(19) United States
(12) Patent Application Publication
(10) Pub. No.: US 2002/0077991 A1
(43) Pub. Date: Jun. 20, 2002

(54) Franking machine control

(76) Inventors: Peter Heimann, Bern (CH); Geza Mihalik, Koeniz (CH); Peter Stutz, Hinterkappelen (CH); Martin Leuch, Guemligen (CH); Philipp Merz, Domach (CH)

Correspondence Address: PERMAN & GREEN, 425 POST ROAD, FAIRFIELD, CT, 06430, US

(21) Appl. No.: 09/888,935

(22) Filed: Jun. 26, 2001

Related U.S. Application Data
(60) Provisional application No. 60/213,922, filed on Jun. 26, 2000.

(51) Int. Cl. G06F 17/60

(52) U.S. Cl. 705/60

(57) ABSTRACT

A system for controlling a franking machine from a remote computer comprises control software for controlling the franking machine, communications apparatus for the franking machine to communicate with the computer, a user application operating on the computer to interface with the control software via the communications apparatus, and a programming library for communicating with the user application, the programming library providing the user application with a series of functional controls of the franking machine. A method for operating a franking machine using the functional controls. A computer readable medium containing the programming library.

This application claims priority under 35 U.S.C. §119(e) from provisional patent serial No. 60/213,922 filed on Jun. 26, 2000, which is hereby incorporated by reference.

### FIELD OF THE INVENTION

The present invention relates to control systems for franking machines. More particularly, it relates to control systems which interface a franking machine with a computer system such as a personal computer or a computer network so that postal meter accountability and security are enhanced.

### BACKGROUND ART

In many businesses, one or more franking machines are used in a mailroom, or several are used in mailrooms in different locations. If such franking machine or machines operate autonomously, there is virtually no easy way to exercise management control, so that it is possible to determine how postage is being used. While in principle, it is possible to keep a postal log stating the purpose of each piece of mail being franked, this takes up an enormous amount of time, is subject to accidental or intentional errors, and provides only minimal information.

### SUMMARY OF THE INVENTION

It is an object of the present invention to provide franking machine control from a computer.

It is another object of the invention to allow a user application to communicate with franking machine control software elements in a computer.

It is yet another object of the invention to allow a user or customer application to easily obtain information needed for management of franking machine operations.

The present invention is directed to a system for controlling a franking machine from a remote computer, comprising control software for controlling the franking machine, communications apparatus for the franking machine to communicate with the computer; a user application operating on the computer to interface with the control software via the communications apparatus; and a programming library for communicating with the user application, the programming library providing the user application with a series of functional controls of the franking machine.

The invention is also directed to a method for remotely operating a franking machine under functional controls provided by the programming library.

The functional controls include at least one item selected from the group consisting of connection, configuration, actions, departments and statistics.

The invention is further directed to a computer readable medium containing the programming library. The computer readable medium may be a magnetic disk, CD, tape, or any other medium which can be read by an appropriate reading device.

### BRIEF DESCRIPTION OF THE DRAWINGS

The foregoing aspects and other features of the present invention are explained in the following description, taken in connection with the accompanying drawings, wherein:

FIG. 1 is an illustration of a computer using the present invention connected to several franking machines.

FIG. 2 illustrates communications between the franking machine and a computer in accordance with FIG. 1.

FIG. 3 illustrates the interface for the program used by the computer of FIG. 1.

FIG. 4 is state diagram of the operation of a franking machine when remote control is implemented.

FIG. 5a, FIG. 5b and FIG. 5c illustrate the manner in which high value limits are processed.

FIG. 6 illustrates a key code arrangement used to prevent unauthorized copying of the software used on the computer of FIG. 1

FIGS. 7a to FIG. 7d are examples of additions to the service menu of a franking machine used in accordance with the invention.

### DETAILED DESCRIPTION OF THE PREFERRED EMBODIMENT

Referring to FIG. 1, a remote computer 10, such as a PC, is connected to one or more postal franking machines 12A, 12B . . . 12N by respective communications lines 14A, 14B, . . . 14N. Communications may be conducted via an RS232 (V.24) serial interface, but the invention is not limited in any such way. Other communications protocols may be used. Further, a LAN/WAN type arrangement may be used to connect computer 10 to the franking machines 12A, 12B . . . 12N, with other protocols such as, for example, TCP/IP. Further, computer 10 need not be a PC, but can be any of several types of computers, such as a mainframe, or other computer associated with the operation of a business.

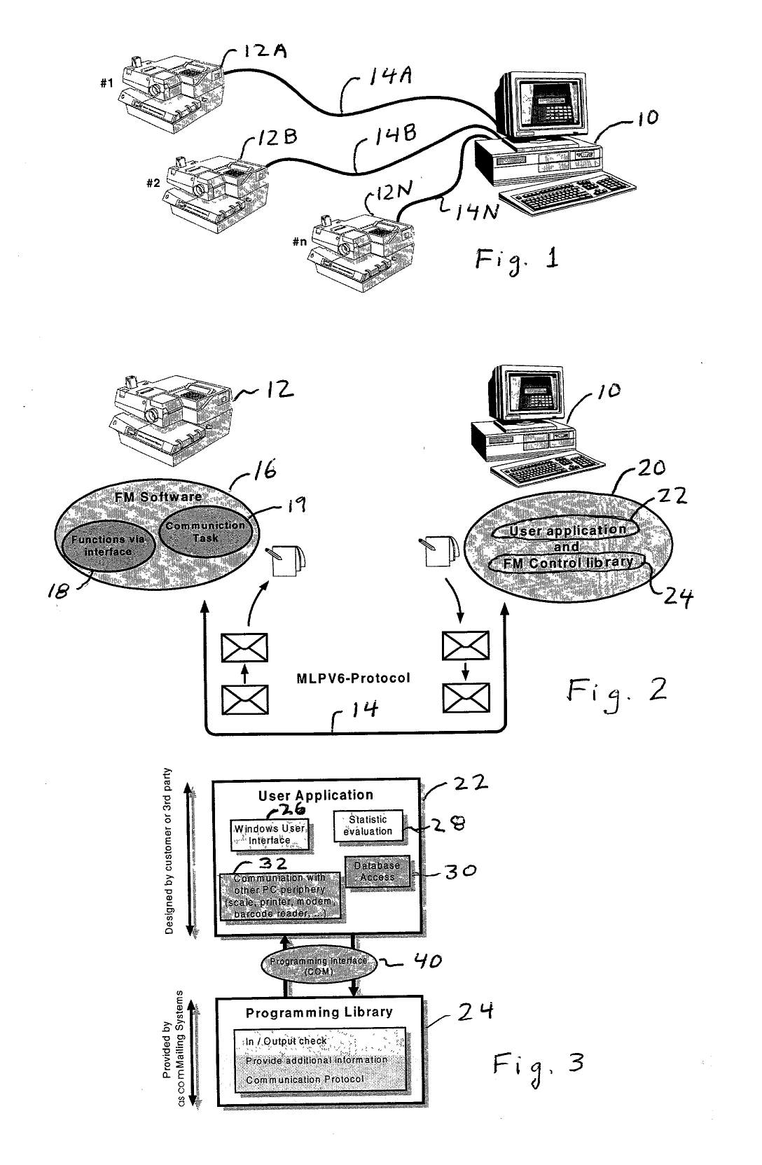

Referring to FIG. 2, each franking machine 12 has associated with it a software package, represented schematically at 16 which includes a remote function package 18 and a communication task or module 19. Remote function package 18 provides franking machine functions via remote control from computer 10 via a software package represented schematically at 20. Software package 20 includes a customer designed user application 22 and a franking machine programming library, also referred to as a control library 24 herein. Communication may be carried on via the RS 232 communication line 14 using, for example, the MLPV6 protocol, developed by Ascom Hasler Mailing Systems of Shelton, Conn. Generally, the franking machine will define line speeds of up to 9600 bps. However, an RS-232 line may be used conservatively at line speeds of 20 Kbps and with line lengths of up to 15 meters.

The franking machine control library 24, is a library, which is integrated into the custom designed application 22. This library allows accessing the franking meter functions from a computer 10 in a comfortable and easy way. It offers the same functionality as is available at the franking meter keyboard. Thus, the entire franking meter user interface can be simulated or rebuilt on computer 10 and adapted to a customer's needs.

As noted above, the main task of the control library 24 is communication with the franking machine. The MLPV6 protocol takes care of the complex and sensitive communication between the computer 10 and franking machine 12. Another important task of the control library 24 is providing an information wrapper. The information wrapping checks the data from the user and the machine and converts it into compatible values (e.g. money values). In addition the control library 24 provides information not explicitly supplied by the franking meter, such as the availability of franking modes, that depend on the base software in the franking machine.

Referring to FIG. 3, user application 22 may include a Windows® interface 26, a statistic evaluation module 28, a database access module 30, and a communication package 32 for communicating with other peripheral devices associated with computer 10 such as, for example, a postage scale, a printer, a modem, a barcode reader, etc. It will be understood that user application 22 will be custom programmed by the user and that many variations on its contact and function are possible. For example, a statistical database may provide information as to customer mailing patterns and behaviors. An audit trail may be provided. Mailroom resources may be more efficiently scheduled, and budget efficiently managed.

Control library 24 may include an input/output check, a source of additional information to a user of library 24 and software for executing an appropriate communication protocol. It may be programmed in a language such as Visual C++.

The control library 24 interfaces to a user application 22 by way of a programming interface 40 in the form of Component Object Model (COM) interface also known as ActiveX. COM is a quasi standard for the Windows environment. It allows accessing the library with almost any Windows programming language. Thus, any programming language can be extended with franking machine functions, that are as easy to use as any built-in command of the programming language.

The control library 24 includes several objects. These objects include Connection, Configuration, Actions, Departments, and Statistics. Each one of these objects has properties, methods and events defined below in an watt Interface Definition document set forth below as Appendix I. The last three pages of Appendix I specify software and hardware requirements, as well as general instructions for use. The term FM used therein refers to a franking machine.

Appendix II is a source code listing of various portions of the programming or control library 24. The following files are included in Appendix II.

Conversions.bas

ErrorHandler.bas

Start.bas

frmAbout.frm

frmConfig.frm

frmCounters.frm

frmDateTime.frm

frmFranking.frm

frmInterface.frm

frmMailClassAdjust.frm

frmMain.frm

frmTextToDisplay.frm

frmconfig.log

Mssccprj.scc

FMCtrlDemo.vbp

FMCtrlDemo.vbw

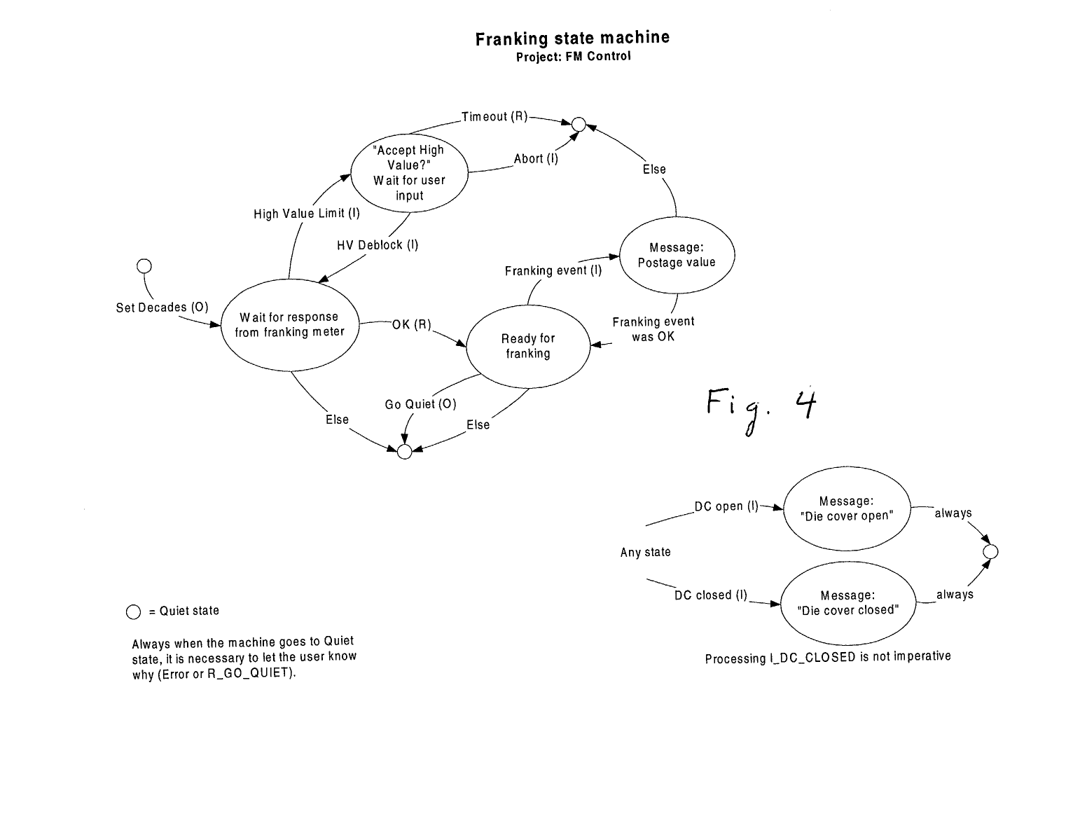

FIG. 4 is a state diagram which is implemented by the programming or control library 24, and is self explanatory to one skilled in the art.

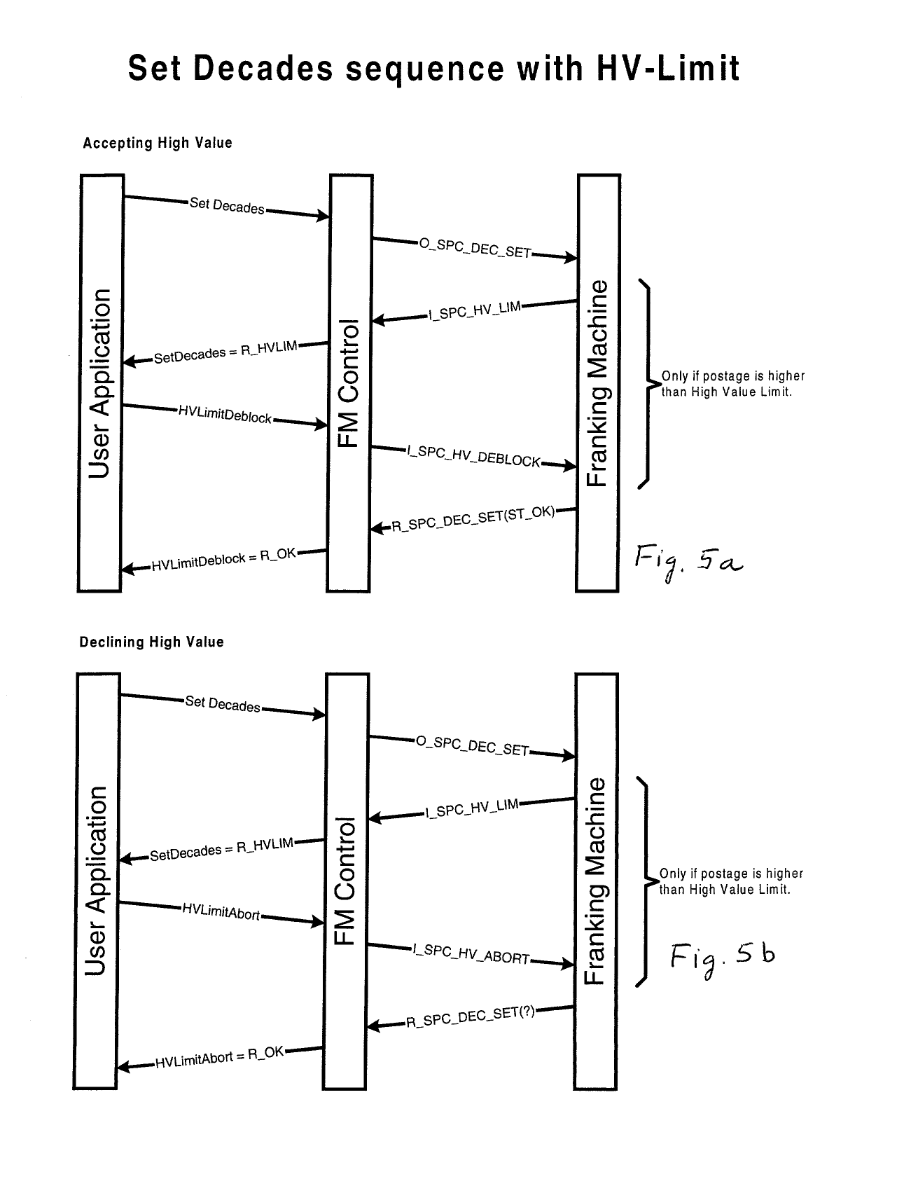

FIG. 5a, FIG. 5b and FIG. 5c illustrate the manner in which high value limits are processed, showing interactions between the user application and the franking machine control on the left, and interaction between the franking machine control and the franking machine, on the right. Other aspects are described in Appendix I.

Most errors which occur in the system are passed as COM-Exceptions over the programming interface to the user application. Only state information that does not represent real errors, but may have the meaning that the function could not be carried out, do come via return values of the COM functions.

A C++ exception calls the destructor of each object that it goes through up to the level where it is caught. This mechanism allows a perfect clean up in case of an exception as long as all the objects are created in the constructor and destroyed in the destructor of objects. The communication of layers (MLPV6 layers) may be taken over from the project service computer for digital postal franking machines. Thus, errors are passed on by return variables through all MLPV6 layers up into the business classes. On business class level the exceptions are thrown out, and on the level of the COM-Interface they are caught. Of course there are also exceptions thrown on the COM-Interface level, especially in the case of invalid input from the user application.

This architecture permits taking advantage of exceptions and at the same time having control over creation and destruction of objects, as the exceptions span only one level.

Referring to FIG. 6, in order to avoid unauthorized copying and use of the franking machine control software, a protection mechanism is implemented in the franking machine software. This mechanism allows enabling of franking machine control remotely only after entering a key code. The key code may depend on the serial number of the franking machine. By this, it is meant that each machine has its own unique key code. A specialized personal computer program may be used for the generation of the key codes. This key code generator is given only to authorized representatives of the manufacturer of the system.

In connection with the key code the term “user” refers to the person who enables the franking machine control feature in the franking machine. It does not matter whether this is the end user, or a technician of a reseller, or any other person.

Referring specifically to FIG. 6, franking machine control is enabled using the following procedure:

1. A user 50 receives a franking machine 10 with software installed that supports franking machine control.

2. The user contacts an authorized representative 52 of the manufacturer with the serial number and software version of the franking machine 10.

3. The representative 52 enters the data received from the user into the key code generator and obtains the key code that is given to the user 50.

4. The user 50 chooses REMOTE CONTROL, in a SERVICE menu of the franking machine 10. At the prompt KEY CODE, the user 50 enters a 16-digit number.

As soon as the correct key code has been entered, the menu REMOTE CONTROL changes to allow switching this feature ON or OFF.

After this procedure the key code does not have to be reentered until new software is installed in the franking machine and/or the memory is cleared (INIA).

Each time new software is installed into the franking machine 10 a new key code is required. This is because the key code depends on the software version. As long as the software does not change, it is not necessary to get a new key code. If the memory is cleared (INIA), the same key code can be reused.

Thus, there is actually no key code management necessary since the key codes can be generated with the information provided by the user (serial number, software version). Key codes do not have to be stored as they can be reproduced at any time.

If key codes are sold to users, it may be necessary to keep some form of list that shows who has already paid for the key code and therefore is entitled to receive a new key code without charge when the software of their meter changes. In this list, the users would be identified by the serial number of their respective franking machine. Keeping such a list is not difficult.

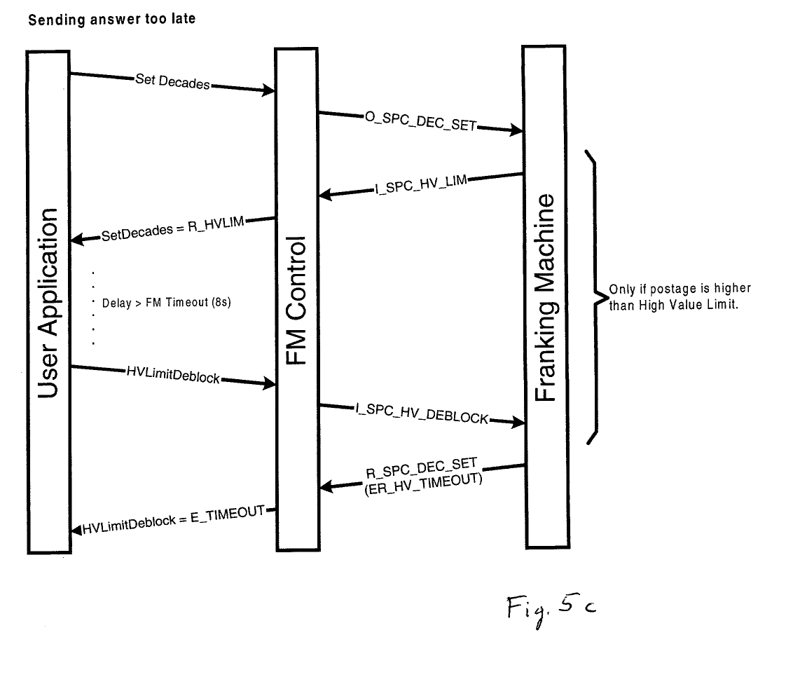

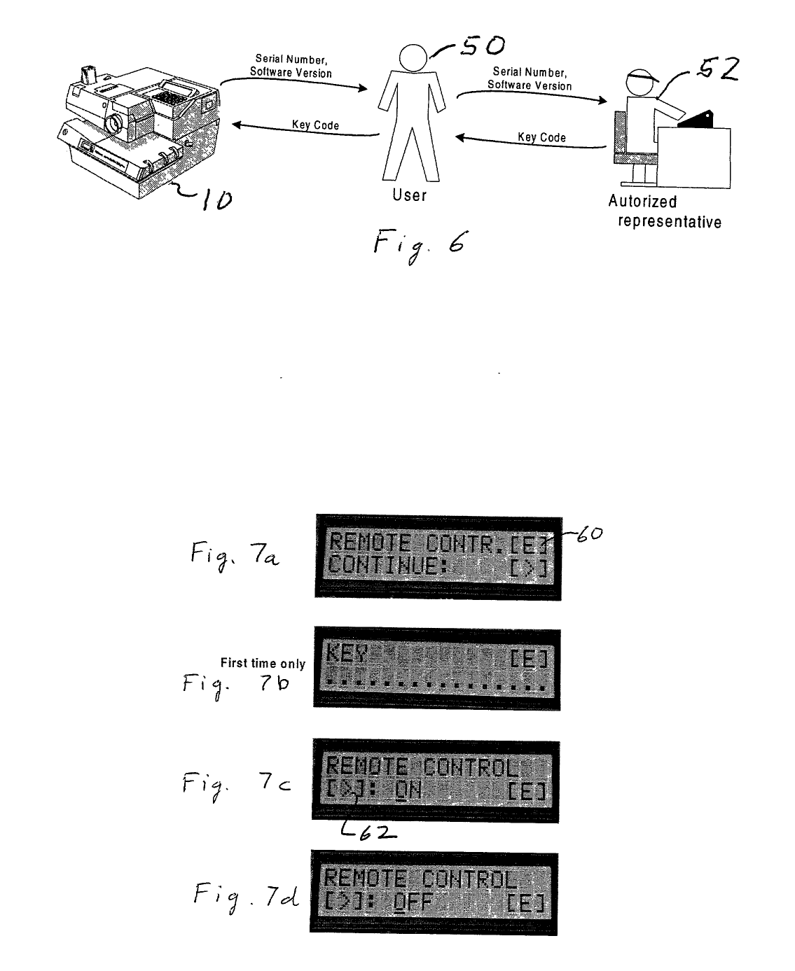

Referring to FIGS. 7a to 7d, the user interface of the franking machine is extended to allow the user to enter the key code. The following is a description of the user interface extensions, explaining the actions of the user.

REMOTE CONTR. [E]

CONTINUE: [>] The menu command REMOTE CONTROL is added to the SERVICE menu.

KEY CODE:

By pressing the E button 60, the user gets to the prompt (only if the correct key code has not yet been entered). With the C-button (not shown) the user can go back to the menu command.

The key code may be a sixteen digit number, such as: 1234567890123456. The user now enters the 16-digit key code.

REMOTE CONTROL (FIG. 7c and FIG. 7d)

FIG. 7c [>]: ON [E] if the entered key code is correct. Remote control can be switched ON and OFF by pressing the > button 62.

If the Key Code is incorrect, the user gets an error message and gets back to the menu (first display; FIG. 7a).

Once the correct key code has been entered, the prompt will not appear again. The user will get directly to the last display FIG. 7d (ON/OFF) when pressing E at the menu command. To avoid abuse by someone trying random codes, the key code can be entered at the keyboard of the franking machine only (not from the computer or any other external device).

The key code generator may be a quite simple and small Windows® program that allows generating key codes by entering the serial number and the software version of the franking machine. It may use a one-way hash algorithm that is already in use in franking machines having certain telemetering system (TMS) functions. Thus, this part of the franking machine software can be reused. The software of other franking machines not so equipped may be enhanced by adding the hash algorithm.

In order to enhance security, it is possible for the input parameters for the hash algorithm to be not only the serial number and the software version, but also a secret key, as described below. The user of the key code generator does not need to know the secret key.

Thus, the hash algorithm that calculates the key code may have three input parameters: serial number and software version of the franking machine and an additional secret key.

This secret key must be known to the key code generator and to the franking meter software that checks the correctness of the entered key code. The secret key is hardcoded in the franking meter software (to be precise: in a parameter file). Since all source code of the franking machine software is stored in a database (MADE), no secret key will be lost and the key code for any meter software ever released, can be reproduced.

The secret key provides additional security against cracking of the key code. Since the hash algorithm is known to the public, it is important to have at least one input parameter that is kept secret.

Another advantage of the introduction of a secret key is its exchangeability. If, for any reason, it becomes necessary to change the key codes, one can introduce a different secret key into the new franking machine software versions. This scenario is practical if the key code generator falls into the wrong hands. The key code generator can determine which secret key to use from the software version, as the secret key is hardcoded into the franking machine software. It is possible for each meter software version to have its own secret key, but this would result in fairly large administrative expenditures. Thus, a simple version of this key code system may have only one secret key for all franking machines.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A system for controlling a franking machine from a remote computer, comprising:
control software for controlling said franking machine;
communications apparatus for said franking machine to communicate with said computer;
a user application operating on said computer to interface with said control software via said communications apparatus; and
a programming library for communicating with said user application, said programming library providing said user application with a series of functional controls of said franking machine.

2. The system of claim 1 wherein said functional controls include at least one item selected from the group consisting of connection, configuration, actions, departments and statistics.

3. A computer readable medium having stored therein computer readable code for interacting with a user application running on a computer communicating with a franking machine, said computer readable code comprising:
a programming library for communicating with said user application, said programming library providing said user application with a series of functional controls of said franking machine.

4. The computer readable medium of claim 3 wherein said functional controls include at least one item selected from the group consisting of connection, configuration, actions, departments and statistics.

5. A method for operating a franking machine which is in communication with a computer, comprising:
running a user application on said computer;
accessing a programming library for communicating with said user application, said programming library providing said user application with a series of functional controls of said franking machine.

6. The method of claim 5 further comprising performing at least one operation using said functional controls, wherein said functional controls include at least one item selected from the group consisting of connection, configuration, actions, departments and statistics.
